(19) United States
(12) Patent Application Publication
(10) Pub. No.: US 2026/0051802 A1
(43) Pub. Date: Feb. 19, 2026

(54) Electromagnetic Brake Mechanism, Baitcasting Reel, and Fishing Tackle

(71) Applicant: Shenzhen Bosaidong Technology Co., Ltd., Shenzhen (CN)

(72) Inventors: Huangshen Qu, Shenzhen (CN); Tianshi Cui, Shenzhen (CN)

(21) Appl. No.: 19/263,518

(22) Filed: Jul. 9, 2025

(30) Foreign Application Priority Data
Aug. 15, 2024 (CN) 202421989188.2

(51) Int. Cl. H02K 49/06; A01K 89/033

(52) U.S. Cl. CPC H02K 49/065; A01K 89/033

(57) ABSTRACT

Disclosed are an electromagnetic brake mechanism a baitcasting reel and a fishing tackle. The electromagnetic brake mechanism includes a line reel; a magnet assembly including a magnetic ring and at least one coil, the magnetic ring sleeving a rotating shaft of the line reel and including a plurality of magnets arranged in a Halbach array; and a brake control circuit connected with the at least one coil to form a closed loop with the at least one coil according to the rotating speed of the line reel so as to generate an induced electromagnetic field and then form a braking force inhibiting the rotation of the line reel. The size of the magnetic ring can be reduced under the same intensity of the magnetic force, so that the overall weight of the line reel is reduced, and the use experience of a user is improved.

### CROSS REFERENCES TO RELATED APPLICATION

The present application claims the benefit of Chinese Patent Application No. 202421989188.2 filed on Aug. 15, 2024, the contents of which are incorporated herein by reference in their entirety.

### TECHNICAL FIELD

The present application relates to the field of fishing tackles, in particular to an electromagnetic brake mechanism, a baitcasting reel, and a fishing tackle.

### BACKGROUND ART

A fishing reel is one of essential fishing tackles for casting rod (offshore casting) fishing. An existing baitcasting reel and fishing tackle with each using an electromagnetic brake may generate a braking force strong enough in a use process, and magnets with volumes large enough are usually mounted on a line reel of the baitcasting reel, which greatly increases the weight of the line reel, so that the casting of a small-weight bait is limited, and the use experience of a user is affected.

### SUMMARY OF THE INVENTION

The technical problem to be solved in the present application is to provide an electromagnetic brake mechanism capable of reducing the weight of a line reel, a baitcasting reel, and a fishing tackle.

In order to solve the above-mentioned technical problem, according to one aspect of the present application, provided is an electromagnetic brake mechanism, including:
a line reel;
a magnet assembly including a magnetic ring and at least one coil, the magnetic ring sleeving a rotating shaft of the line reel and including a plurality of magnets arranged in a Halbach array; and
a brake control circuit connected with the at least one coil to form a closed loop with the at least one coil according to the rotating speed of the line reel so as to generate an induced electromagnetic field and then form a braking force inhibiting the rotation of the line reel.

A further technical solution is that the magnet assembly further includes a mounting assembly, the mounting assembly includes a first support, the first support is fixed in the line reel, and the magnetic ring is located on an upper surface of the first support and is located on an end surface of the line reel.

A further technical solution is that the mounting assembly further includes a second support, the second support is located above the magnetic ring, and the at least one coil is located on the second support.

A further technical solution is that the magnet assembly further includes a mounting assembly, the mounting assembly includes a third support, the at least one coil is mounted in the line reel via the third support, four coils are provided, and the four coils are disposed around the magnetic ring and are connected with the brake control circuit after connected in series.

A further technical solution is that the third support includes a hollow mounting sleeve, the four coils are embedded into the mounting sleeve, the magnetic ring is located in the mounting sleeve, and the rotating shaft penetrates through the magnetic ring.

A further technical solution is that the electromagnetic brake mechanism further includes a side cover assembly covering one side of the line reel, and the rotating shaft of the line reel is located in the side cover assembly after penetrating through the magnetic ring.

A further technical solution is that the brake control circuit includes a sensor, a controller, and two MOS (Metal Oxide Semiconductor) transistors, the sensor is used for detecting the rotating speed of the line reel, four coils are provided, the four coils are connected to drain electrodes of the two MOS transistors after connected in series, source electrodes of the two MOS transistors are both grounded, the controller is connected with the sensor and grid electrodes of the two MOS transistors to obtain a line outgoing speed according to the rotating speed of the line reel and control the work of the MOS transistors according to the rotating speed and the line outgoing speed of the line reel, and then, the closed loop is formed.

In order to solve the above-mentioned technical problem, according to another aspect of the present application, provided is a baitcasting reel, including a fishing reel main body and an electromagnetic brake mechanism connected with the fishing reel main body, the electromagnetic brake mechanism being the above-mentioned electromagnetic brake mechanism.

In order to solve the above-mentioned technical problem, the present application further provides a fishing tackle, including the above-mentioned baitcasting reel.

Compared with the prior art, the magnetic ring in the magnet assembly in the present application is composed of the plurality of magnets arranged in the Halbach array, so that magnetic induction lines of the magnetic ring are denser, and then, the intensity of a magnetic field is improved; a relatively strong magnetic force can be achieved by using the relatively small magnets, so that the effect that the small magnets have the strong magnetic force is achieved; the size of the magnetic ring can be reduced under the same intensity of the magnetic force, so that the overall weight of the line reel is reduced, and the use experience of a user is improved; and the magnetic induction lines of the magnetic ring are concentrated above the magnetic ring, and are less distributed on the bottom of the magnetic ring, so that influences on a bearing in the rotating shaft can be further reduced.

### BRIEF DESCRIPTION OF THE DRAWINGS

FIG. 1 is a schematic diagram of a three-dimensional structure of a first embodiment of an electromagnetic brake mechanism in the present application;

FIG. 2 is a schematic diagram of an exploded structure of a first embodiment of an electromagnetic brake mechanism in the present application;

FIG. 3 is a schematic sectional view of a first embodiment of an electromagnetic brake mechanism in the present application;

FIG. 4 is a schematic diagram of a specific structure of a magnetic ring in the electromagnetic brake mechanism shown in FIG. 2;

FIG. 5 is a schematic diagram of an exploded structure of a second embodiment of an electromagnetic brake mechanism in the present application; and

FIG. 6 is a schematic sectional view of a second embodiment of an electromagnetic brake mechanism in the present application;

FIG. 7 is a circuit schematic diagram of a brake control circuit according to an embodiment of the present application.

### DETAILED DESCRIPTION OF THE INVENTION

In order to make those of ordinary skill in the art understand the objects, technical solutions and advantages of the present application more clearly, the present application will be further described below in conjunction with the accompanying drawings and embodiments.

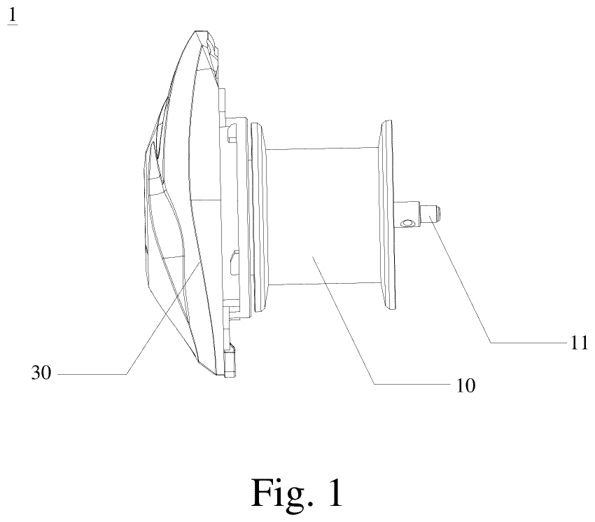

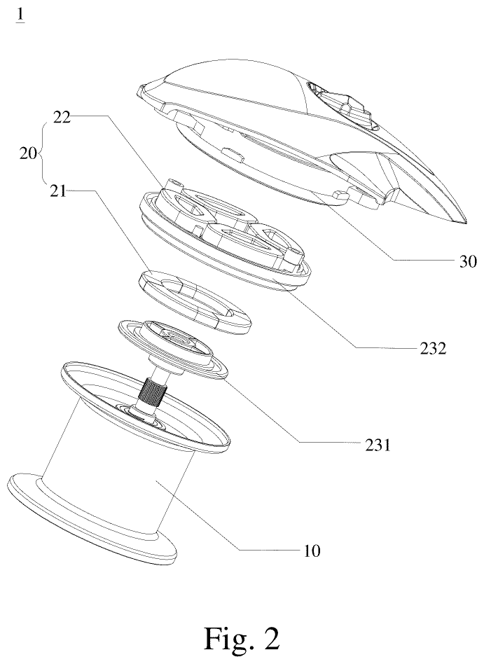

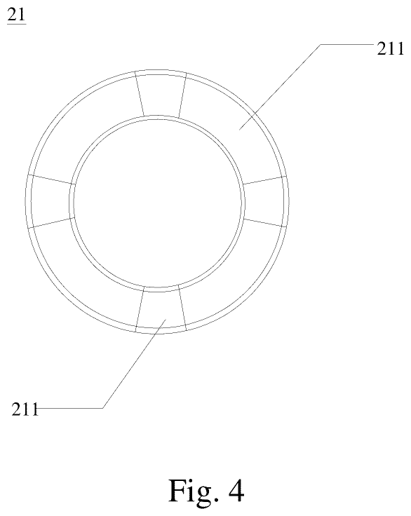

Referring to FIG. 1 to FIG. 4, FIG. 1 to FIG. 4 show a first embodiment of an electromagnetic brake mechanism 1 in the present application. In the embodiment shown in the accompanying drawings, the electromagnetic brake mechanism 1 includes a line reel 10, a magnet assembly 20, and a brake control circuit; wherein the magnet assembly 20 includes a magnetic ring 21 and at least one coil 22, the magnetic ring 21 is used for generating magnetic induction lines, sleeves a rotating shaft 11 of the line reel 10, and includes a plurality of magnets 211 arranged in a Halbach array (as shown in FIG. 2 and FIG. 4); and the brake control circuit is connected with the at least one coil 22 to form a closed loop with the at least one coil 22 according to the rotating speed of the line reel 10 so as to generate an induced electromagnetic field and then form a braking force inhibiting the rotation of the line reel 10. Based on the above-mentioned design, the magnetic ring 21 in the magnet assembly 20 in the present application is composed of the plurality of magnets 211 arranged in the Halbach array, so that the magnetic induction lines located above the magnetic ring 21 are denser, and then, the intensity of a magnetic field is improved; a relatively strong magnetic force can be achieved by using the relatively small magnets, so that the effect that the small magnets have the strong magnetic force is achieved; the size of the magnetic ring 21 can be reduced under the same intensity of the magnetic force, so that the overall weight of the line reel 10 is reduced, and the use experience of a user is improved; and the magnetic induction lines of the magnetic ring 21 are concentrated above the magnetic ring 21, and are less distributed on the bottom of the magnetic ring, so that influences on a bearing in the rotating shaft 11 can be further reduced. During work, the magnetic ring 21 is formed with a permanent magnetic field, in a process that the magnetic ring 21 rotates with the line reel 10, since the at least one coil 22 is located in the magnetic field, the loop formed by the line reel 10 and the at least one coil 22 can be closed when it is detected by the brake control circuit that the rotation speed of the line reel 10 is overhigh, so that the at least one coil 22 generates an induction current, and then generates an induced electromagnetic field; and it can be known according to the Lenz's law that a torque hindering the movement of the magnetic ring 21 is generated to hinder the movement of the magnetic ring 21, that is, a torque (braking force) opposite to a rotation direction of the line reel 10 is generated to inhibit the rotation of the line reel 10.

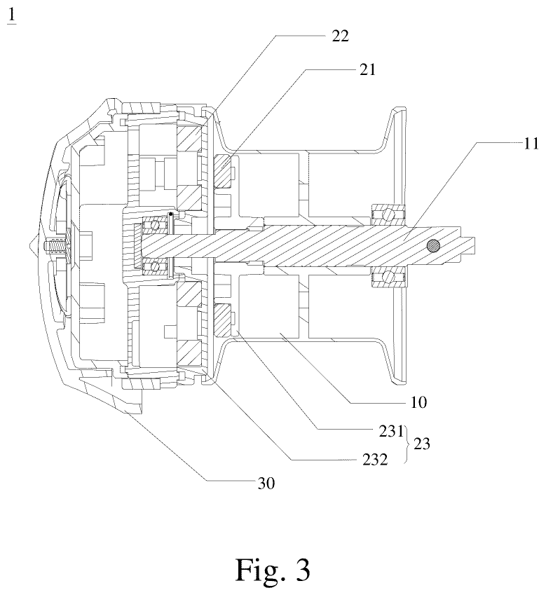

Further referring to FIG. 2 and FIG. 3, in the present embodiment, the magnet assembly 20 further includes a mounting assembly 23, the mounting assembly 23 includes a first support 231 and a second support 232, the first support 231 is fixed in the line reel 10, the magnetic ring 21 is located on an upper surface of the first support 231 and is located on an end surface of the line reel 10, the second support 232 is located above the magnetic ring 21, and the at least one coil 22 is located on the second support 232. Preferably, in the present embodiment, four coils 22 are provided, and the four coils 22 are disposed on an upper surface of the second support 232 and can be connected with the brake control circuit after connected in series by a conducting wire. Understandably, in some other embodiments, the number of the at least one coil 22 can be increased or reduced according to an actual demand. Based on the above-mentioned design, in the present embodiment, the at least one coil 22 is located above the magnetic ring 21, and the magnets 211 arranged in the Halbach array can make the magnetic induction lines located above the magnetic ring 21 denser, so that the at least one coil 22 can generate a relatively strong inducted electromagnetic field, and then, the rotation of the line reel 10 can be inhibited rapidly.

In some embodiments, the electromagnetic brake mechanism 1 further includes a side cover assembly 30 covering one side of the line reel 10, and the rotating shaft 11 of the line reel 10 is located in the side cover assembly 30 after penetrating through the magnet assembly 20, and the second support 232 can be fixed on the side cover assembly 30.

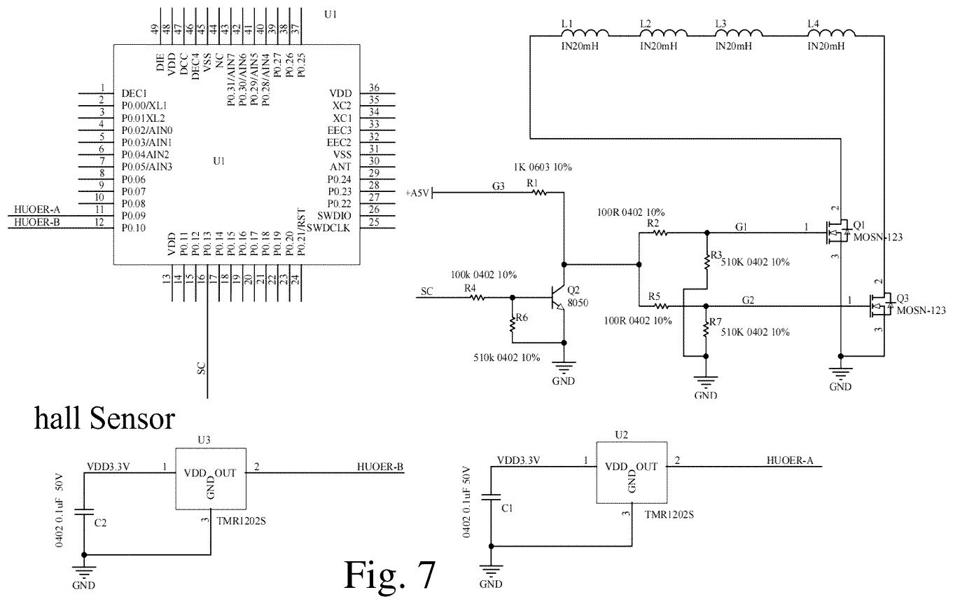

In some embodiments, as shown in FIG. 7, the brake control circuit can include a sensor U2/U3, a controller U1, and two MOS transistors Q1 and Q3, the sensor U2/U3 is used for detecting the rotating speed of the line reel 10, the four coils 22 are connected to drain electrodes of the two MOS transistors Q1 and Q3 after connected in series, source electrodes of the two MOS transistors Q1 and Q3 are both grounded, the controller U1 is connected with the sensor U2/U3 and grid electrodes of the two MOS transistors Q1 and Q3 to obtain a line outgoing speed according to the rotating speed of the line reel 10 and control the work of the MOS transistors Q1 and Q3 according to the rotating speed and the line outgoing speed of the line reel 10, and then, the closed loop is formed. In the present embodiment, as shown in FIG. 7, two sensors U2 and U3 may be provided simultaneously to detect the clockwise and counterclockwise movements of the line reel 10. When the angler casts the fishing line, the line reel 10 rotates clockwise, and a braking force is applied based on the rotational speed of the line reel 10. When the angler retrieves the fishing line, the line reel 10 rotates counterclockwise, and no braking force is applied regardless of the rotational speed of the line reel 10, so as to prevent the braking force from affecting the tactile sensation during fishing reel operation. Preferably, the sensor U2/U3 can be a Hall sensor, and the controller U1 can be a microcontroller or a single chip microcomputer, etc. Understandably, the controller U1 and the MOS transistors Q1 and Q3 can be arranged on a circuit board, the circuit board can be located in the side cover assembly 30, and the controller U1 can also change the braking force by controlling and adjusting turn-on time of the two MOS transistors Q1 and Q3 so as to automatically adjust the braking force and balance the rotating speed and line outgoing speed of the line reel 10. When braking is required, the two MOS transistors Q1 and Q3 are turned on at the same time, the four coils 22 are short-circuited to form the closed loop, and each coil 22 forms an induced electromagnetic field; understandably, the polarity of the induced electromagnetic field can be the same as or opposite to the polarity of the permanent magnetic field generated by the magnetic ring 21; according to the Lenz's law, the electromagnetic field of the induction current always hinders the change of a magnetic flux inducing the induction current, when the permanent magnetic field formed by the magnetic ring 21 is enhanced, the polarity of the induced electromagnetic field generated by the coil 22 is opposite to that of the permanent magnetic field, while the permanent magnetic field is weakened, the polarity of the induced electromagnetic field generated by the coil 22 is the same as that of the permanent magnetic field, and a torque hindering the movement of the magnetic ring 21 is always generated to hinder the rotation of the line reel 10; it can be known that due to the continuous high-speed rotation of the line reel 10, a continuous braking torque can be formed to complete a braking action; and by adjusting the closing time of the at least one coil 22, i.e., the turn-on time of the two MOS transistors Q1 and Q3, the braking force can be adjusted, if the turn-on time is prolonged, the braking force is increased, and if the turn-on time is shortened, the braking force is reduced

It can be known from above that in the present application, by changing placement positions of the magnets 211 and arranging the magnets in the Halbach array, the magnetic induction lines of the magnetic ring 21 can be denser, and then, the intensity of a magnetic field is improved; a relatively strong magnetic force can be achieved by using the relatively small magnets, so that the effect that the small magnets have the strong magnetic force is achieved; the size of the magnetic ring 21 can be reduced under the same intensity of the magnetic force, so that the overall weight of the line reel 10 is reduced, and the use experience of a user is improved; and the magnetic induction lines of the magnetic ring 21 are concentrated above the magnetic ring 21, and are less distributed on the bottom of the magnetic ring 21, so that the at least one coil 22 located above the magnetic ring 21 can generate a relatively strong induced electromagnetic field, and meanwhile, influences on a bearing in the rotating shaft 11 can be reduced.

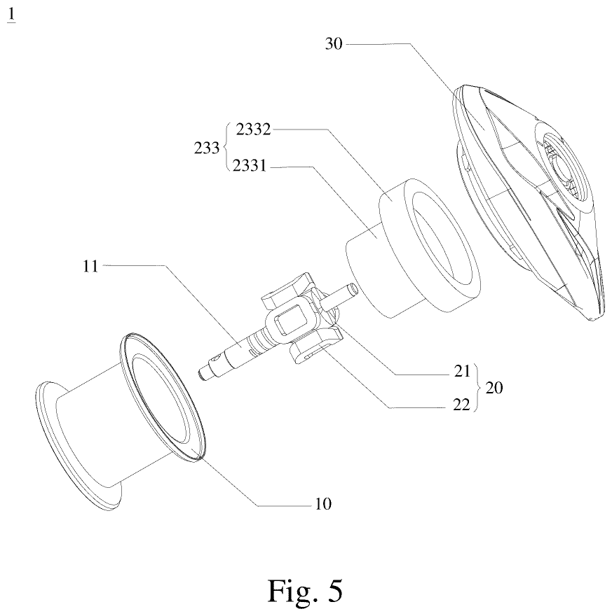

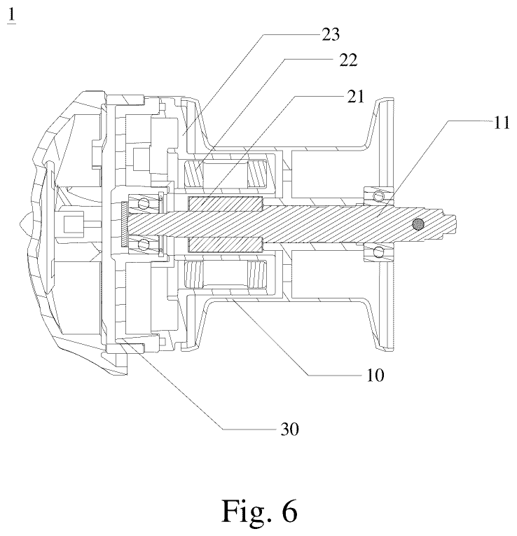

Referring to FIG. 5 to FIG. 6, FIG. 5 to FIG. 6 show a second embodiment of an electromagnetic brake mechanism 1 in the present application. The present embodiment differs from the first embodiment in that all the structures except positions of the magnetic ring 21 and the at least one coil 22 and the mounting assembly 23 in the magnet assembly 20 are similar or the same. In the present embodiment, the mounting assembly 23 includes a third support 233, the at least one coil 22 is mounted in the line reel 10 via the third support 233, four coils 22 are provided, and the four coils 22 are disposed around the magnetic ring 21 and are connected with the brake control circuit after connected in series. Specifically, the third support 233 includes a hollow mounting sleeve 2331, the four coils 22 are embedded into the mounting sleeve 2331, the magnetic ring 21 is located in the mounting sleeve 2331, the rotating shaft 11 penetrates through the magnetic ring 21, and the magnetic ring 21 is fixed on the rotating shaft 11. In order to stabilize the position of the magnet assembly 20, the third support 233 further includes a connecting part 2332 formed by extending from a top edge of the mounting sleeve 2331 to the outside and the upside, and the connecting part 2332 is fixed on the side cover assembly 30. In the present embodiment, the object of reducing the overall weight of the line reel 10 can also be achieved, and the braking force can also be automatically adjusted.

Understandably, in other embodiments of the present application, further provided is a baitcasting reel, including a fishing reel main body and the electromagnetic brake mechanism in the above-mentioned embodiment, the line reel and other parts in the electromagnetic brake mechanism can be assembled in the fishing reel main body, and the side cover assembly is connected with the fishing reel main body. Meanwhile, further provided is a fishing tackle including the above-mentioned baitcasting reel, and all the structures except the baitcasting reel of the fishing tackle can be the same as structures of conventional fishing tackles in the prior art, for example, a fishing rod, a fishing line and other parts can be disposed, and structures thereof are well known by the skilled in the art so as to be no longer repeated herein.

The above descriptions are only preferred embodiments of the present application, rather than limitations on the present application in any form. Various equivalent alterations or improvements can be made by the skilled in the art on the basis of the above-mentioned embodiments, and any equivalent changes or modifications made within the scope of the claims shall fall within the protective scope of the present application.

1. An electromagnetic brake mechanism, comprising:
a line reel;
a magnet assembly comprising a magnetic ring and at least one coil, the magnetic ring sleeving a rotating shaft of the line reel and comprising a plurality of magnets arranged in a Halbach array; and
a brake control circuit connected with the at least one coil to form a closed loop with the at least one coil according to the rotating speed of the line reel so as to generate an induced electromagnetic field and then form a braking force inhibiting the rotation of the line reel.

2. The electromagnetic brake mechanism of claim 1, wherein the magnet assembly further comprises a mounting assembly, the mounting assembly comprises a first support, the first support is fixed in the line reel, and the magnetic ring is located on an upper surface of the first support and is located on an end surface of the line reel.

3. The electromagnetic brake mechanism of claim 2, wherein the mounting assembly further comprises a second support, the second support is located above the magnetic ring, and the at least one coil is located on the second support.

4. The electromagnetic brake mechanism of claim 1, wherein the magnet assembly further comprises a mounting assembly, the mounting assembly comprises a third support, the at least one coil is mounted in the line reel via the third support, four coils are provided, and the four coils are disposed around the magnetic ring and are connected with the brake control circuit after connected in series.

5. The electromagnetic brake mechanism of claim 4, wherein the third support comprises a hollow mounting sleeve, the four coils are embedded into the mounting sleeve, the magnetic ring is located in the mounting sleeve, and the rotating shaft penetrates through the magnetic ring.

6. The electromagnetic brake mechanism of claim 1, wherein the electromagnetic brake mechanism further comprises a side cover assembly covering one side of the line reel, and the rotating shaft of the line reel is located in the side cover assembly after penetrating through the magnetic ring.

7. The electromagnetic brake mechanism of claim 1, wherein the brake control circuit comprises a sensor, a controller, and two MOS (Metal Oxide Semiconductor) transistors, the sensor is used for detecting the rotating speed of the line reel, four coils are provided, the four coils are connected to drain electrodes of the two MOS transistors after connected in series, source electrodes of the two MOS transistors are both grounded, the controller is connected with the sensor and grid electrodes of the two MOS transistors to obtain a line outgoing speed according to the rotating speed of the line reel and control the work of the MOS transistors according to the rotating speed and the line outgoing speed of the line reel, and then, the closed loop is formed.

8. A baitcasting reel, comprising a fishing reel main body and an electromagnetic brake mechanism connected with the fishing reel main body, the electromagnetic brake mechanism being the electromagnetic brake mechanism of claim 1.

9. A baitcasting reel, comprising a fishing reel main body and an electromagnetic brake mechanism connected with the fishing reel main body, the electromagnetic brake mechanism being the electromagnetic brake mechanism of claim 2.

10. A baitcasting reel, comprising a fishing reel main body and an electromagnetic brake mechanism connected with the fishing reel main body, the electromagnetic brake mechanism being the electromagnetic brake mechanism of claim 3.

11. A baitcasting reel, comprising a fishing reel main body and an electromagnetic brake mechanism connected with the fishing reel main body, the electromagnetic brake mechanism being the electromagnetic brake mechanism of claim 4.

12. A baitcasting reel, comprising a fishing reel main body and an electromagnetic brake mechanism connected with the fishing reel main body, the electromagnetic brake mechanism being the electromagnetic brake mechanism of claim 5.

13. A baitcasting reel, comprising a fishing reel main body and an electromagnetic brake mechanism connected with the fishing reel main body, the electromagnetic brake mechanism being the electromagnetic brake mechanism of claim 6.

14. A baitcasting reel, comprising a fishing reel main body and an electromagnetic brake mechanism connected with the fishing reel main body, the electromagnetic brake mechanism being the electromagnetic brake mechanism of claim 7.

15. A fishing tackle, comprising the baitcasting reel of claim 8.

16. A fishing tackle, comprising the baitcasting reel of claim 9.

17. A fishing tackle, comprising the baitcasting reel of claim 10.

18. A fishing tackle, comprising the baitcasting reel of claim 11.

19. A fishing tackle, comprising the baitcasting reel of claim 12.

20. A fishing tackle, comprising the baitcasting reel of claim 13.
